(19) United States
(12) Patent Application Publication
(10) Pub. No.: US 2024/0430321 A1
(43) Pub. Date: Dec. 26, 2024

(54) SERVICE CONTROL SYSTEM, DEVICE, AND METHOD

(71) Applicant: NEC Corporation, Minato- ku, Tokyo (JP)

(72) Inventors: Kosei Kobayashi, Tokyo (JP); Yusuke Shinohara, Tokyo (JP); Takanori lwai, Tokyo (JP); Hayato Itsuni, Tokyo (JP); Koichi Nihei, Tokyo (JP); Kazuki Ogata, Tokyo (JP); Kei Yanagisawa, Tokyo (JP)

(73) Assignee: NEC Corporation, Minato- ku, Tokyo (JP)

(21) Appl. No.: 18/701,648

(22) PCT Filed: Nov. 18, 2021
(86) PCT No.: PCT/JP2021/042426

§ 371 Date: Apr. 16, 2024

(51) Int. Cl. H04L 67/1008

(52) U.S. Cl. CPC H04L 67/1008

(57) ABSTRACT

A server switching decision unit decides whether to switch a server that provides a service to a service-utilizing terminal that receives the service from the server. In a case in which the server switching decision unit makes a decision to switch the server, the server decision unit decides a server of a switching destination from among a plurality of servers that are able to provide the service to the service-utilizing terminal in consideration of an allowable delay satisfaction duration indicating a length of time during which the service can be provided to the service-utilizing terminal with a delay time within an allowable delay time.

### TECHNICAL FIELD

The present disclosure relates to a service control system, device, and method.

### BACKGROUND ART

As a related art, Patent Literature 1 discloses an edge computing system. A plurality of edge host computer devices described in Patent Literature 1 are provided. In the edge computing system, an edge host computer device that provides a specific service calculates a calculation delay time on the basis of a situation of a calculation load. The edge host computer device calculates a communication delay time required for communication between a terminal device requesting the specific service and the edge host computer device. The edge host computer device predicts a response delay time of the specific service on the basis of the calculation delay time and the communication delay time.

In a case in which the predicted response delay time exceeds a predetermined delay time, the edge host computer device that provides the specific service inquires of other edge host computer devices about the response delay time of the specific service. The other edge host computer devices predict the response delay time of the specific service in a similar manner to that described above, and transmit the predicted response delay time to the edge host computer device. The edge host computer device decides an edge host computer device that is to provide the specific service on the basis of its response delay time and the response delay times of the other edge host computer devices. Thereafter, the decided edge host computer device provides the specific service to the terminal device.

As another related art, Patent Literature 2 discloses a management device used in a mobile/multi-access edge computing (MEC) system. The MEC system includes one or more physical resources connected to at least one of a plurality of network elements which constitute a mobile communications system and are disposed at a position physically close to the at least one network element. In Patent Literature 2, the management device manages a virtual environment which is constructed by using at least one of one or more physical resources.

The management device acquires delay requirements indicating an allowable range regarding the delay of the mobile communication system for the service-utilizing terminal. In a case in which access from the service-utilizing terminal to the mobile communication system is detected, the management device specifies a base station accessed by the service-utilizing terminal among a plurality of base stations included in the mobile communication system. The management device decides the physical resource to be used for constructing the virtual environment provided to the service-utilizing terminal on the basis of delay information indicating the delay between the specified base station and each of one or more physical resources.

In the decision of the physical resource, the management server decides the physical resource used for constructing the virtual environment such that the acquired delay requirement is satisfied in consideration of the delay. For example, the management device decides the physical resource used for constructing the virtual environment on the basis of geographical position information of the base station specified as a network edge, that is, the base station accessed by the service-utilizing terminal. In the decision of the physical resource, the physical resource at a distance close to the network edge is preferentially selected.

### CITATION LIST

### Patent Literature

Patent Literature 1: Japanese Unexamined Patent Application Publication No. 2020-137067

Patent Literature 2: Japanese Unexamined Patent Application Publication No. 2019-213161

### SUMMARY OF INVENTION

### Technical Problem

However, in Patent Literature 1, the movement of the terminal device is not considered in server switching. In Patent Literature 1, when the terminal device keeps moving after server switching, the response delay time of the switched edge host computer exceeds the allowable delay time, and switching of the edge host computer is further required. Therefore, in Patent Literature 1, switching of the edge host computer is likely to frequently occur. The frequent switching of the edge host computer leads to frequent interruptions or disconnections of services associated with the switching process, resulting in user dissatisfaction, potential unexpected accidents, or the like.

In Patent Literature 2, in the construction of the virtual environment, the physical resource closest to the network edge is preferentially selected. At the time when the service-utilizing terminal moves and the virtual environment is constructed, the physical resource closest to the network edge is considered to be the physical resource optimal for service provision. However, in Patent Literature 2, in a case in which the service-utilizing terminal keeps moving after the virtual environment is constructed, the closest physical resource at the time of switching is not necessarily the optimal physical resource. In Patent Literature 2, in a case in which the service-utilizing terminal keeps moving and the network edge changes, it is likely that it is necessary to reconstruct the virtual environment frequently. The reconstruction of the virtual environment leads to frequent interruptions or disconnections of services associated with the reconstruction process, resulting in user dissatisfaction, potential unexpected accidents, or the like.

The present disclosure was made in light of the above circumstances, and it is an object of the present disclosure to provide a service control system, device, and method which are capable of suppressing the occurrence of frequent server switching in a case in which a device receiving a service moves.

### Solution to Problem

In order to achieve the above object, the present disclosure provides, as a first aspect, a service control system. A service provision system includes a server switching decision unit configured to decide whether to switch a server that provides a service to a service-utilizing terminal that receives the service from the server and a server decision unit configured to decide a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

The present disclosure provides, as a second aspect, a service control device. A service provision device includes a server switching decision unit configured to decide whether to switch a server that provides a service to a service-utilizing terminal that receives the service from the server and a server decision unit configured to decide a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

The present disclosure provides, as a third aspect, a service control method. A service provision method includes deciding whether to switch a server that provides a service to a service-utilizing terminal that receives the service from the server and deciding a server of a switching destination, when a decision to switch the server is made, from among a plurality of servers that are able to provide the service to the service-utilizing terminal in consideration of an allowable delay satisfaction duration indicating a length of time during which the service can be provided to the service-utilizing terminal with a delay time within an allowable delay time.

### Advantageous Effects of Invention

The service control system, device, and method according to the present disclosure can suppress the occurrence of frequent server switching even in a case in which a device receiving a service moves.

### BRIEF DESCRIPTION OF DRAWINGS

FIG. 1 is a block diagram illustrating a service control device according to a first example embodiment of the present disclosure.

FIG. 2 is a block diagram illustrating a service provision system.

FIG. 3 is a flowchart illustrating an operation procedure in a service control device.

FIG. 4 is a block diagram illustrating a service provision system including a service control device according to a second example embodiment of the present disclosure.

FIG. 5 is a block diagram illustrating a configuration example of a server system.

FIG. 6 is a block diagram illustrating a configuration example of a service control device.

FIG. 7 illustrates an operation procedure in a service control device.

FIG. 8 is a schematic diagram schematically illustrating an example of server switching.

FIG. 9 is a block diagram illustrating a configuration example of a computer device.

### EXAMPLE EMBODIMENT

Hereinafter, example embodiments according to the present disclosure will be described in detail with reference to the drawings. Note that omission and simplification are made as appropriate in the description and drawings described below for clarity of description. In addition, in each of the drawings described below, the same elements and similar elements are denoted by the same reference signs, and a duplicate description is omitted as necessary.

FIG. 1 illustrates a service control device according to a first example embodiment of the present disclosure. A service control device 100 includes a server switching decision unit 101 and a server decision unit 102. The service control device 100 controls a server that provides a service to a service-utilizing terminal that receives a service from a server. The service control device 100 is configured as a device including, for example, one or more processors and one or more memories. At least a part of functions of the units in the service control device 100 may be implemented such that a processor executes a process in accordance with a program read from a memory.

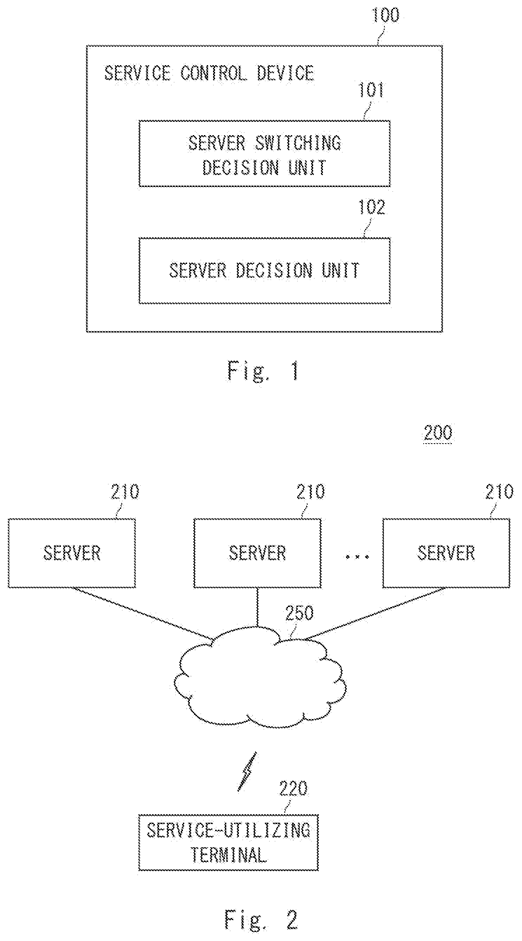

FIG. 2 illustrates a service provision system including the server controlled by the service control device 100. The service provision system 200 includes a plurality of servers 210 and a service-utilizing terminal 220. In the service provision system 200, a plurality of servers 210 and the service-utilizing terminal 220 are connected to each other via a network 250. The network 250 includes, for example, a wireless communication network using a communication line standard such as a fourth generation mobile communication system or long term evolution (LTE). The network 250 may include a wireless communication network, such as WiFi (registered trademark), or 5th generation mobile communication system (5G), or local 5G.

The server 210 is a server capable of providing a service to the service-utilizing terminal 220. The service-utilizing terminal 220 receives a service from any of a plurality of servers 210 via the network 250. The service-utilizing terminal 220 is configured as, for example, a device such as an in-vehicle communication device mounted on a mobile object such as a vehicle, a car navigation device, or a display audio (DA). Alternatively, the service-utilizing terminal 220 may be a device such as a smartphone or a tablet carried by a user. Examples of the service provided to the service-utilizing terminal 220 include an emergency (such as collision) alert service, a traffic jam information distribution service, an approach notification service of an emergency vehicle, and a dynamic map distribution service. Further, the service may be an entertainment-based service such as a music distribution service and a video distribution service.

In the present example embodiment, the service control device 100 controls the server that provides the service to the service-utilizing terminal 220 among a plurality of servers 210. The service control device 100 may be configured as a MEC Orchestrator (MEO) that manages a plurality of servers 210 that are, for example, MEC servers. The service control device 100 may be connected to the server 210 via the network 250, or may be connected to the server 210 via a network different from the network 250.

Note that, in the present example embodiment, it is not necessarily required for the service control device 100 to be physically configured as one device. The service control device 100 may include a plurality of devices connected to each other via a network. For example, the server switching decision unit 101 and the server decision unit 102 may be configured as separate devices. In this case, the service control device 100 is also referred to as a service control system. At least one of the server switching decision unit 101 and the server decision unit 102 may be disposed on a cloud. The server switching decision unit 101 and the server decision unit 102 may communicate with each other via a network such as the Internet. Some or all of the functions of the service control device 100 may be included in any of a plurality of servers 210.

In a case in which the service is being provided to the service-utilizing terminal 220 from one server 210, the server switching decision unit 101 makes a decision to switch the server that provides the service to the service-utilizing terminal 220. For example, the server switching decision unit 101 acquires, for example, the delay time between the service-utilizing terminal 220 and the server 210 providing the service to the service-utilizing terminal 220. The delay time may be an actual measurement value or a predicted value. The server switching decision unit 101 decides whether to switch the server that provides the service to the service-utilizing terminal 220 on the basis of the delay time. Alternatively, the server switching decision unit 101 may decide whether to switch the server that provides the service to the service-utilizing terminal 220 on the basis of position information of the service-utilizing terminal 220. For example, a predetermined area is set as a management area in each server. The server switching decision unit 101 may make a decision to switch the server in a case in which the position of the service-utilizing terminal 220 is out of the management area of the server 210 in which the service is being provided or is predicted to be out of the management area.

In a case in which the server switching decision unit 101 makes a decision to switch the server that provides the service to the service-utilizing terminal 220, the server decision unit 102 decides the server 210 of a switching destination. The server decision unit 102 decides the server 210 of the switching destination, from among a plurality of servers 210 that can provide the service to the service-utilizing terminal 220, in consideration of an allowable delay satisfaction duration. Here, the allowable delay satisfaction duration indicates a length of time during which the service can be provided to the service-utilizing terminal 220 with a delay time within an allowed delay time.

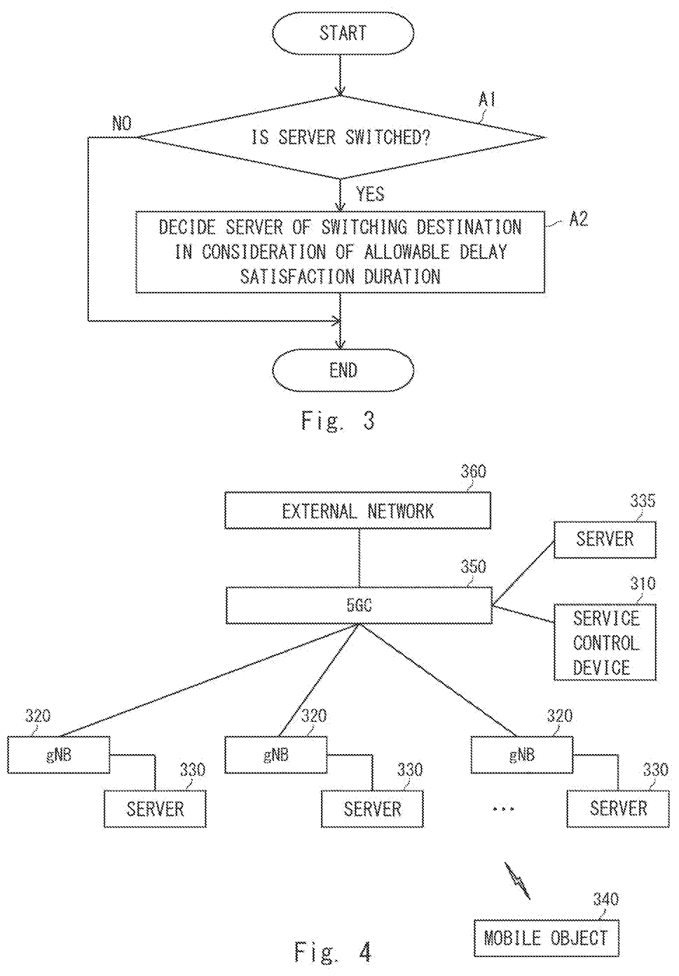

Next, an operation procedure will be described. FIG. 3 illustrates an operation procedure (service control method) in the service control device 100. The server switching decision unit 101 determines whether to switch the server that provides the service to the service-utilizing terminal 220 (step A1). In a case in which it is determined in step A1 that the server is to be switched, the server decision unit 102 decides the server 210 of the switching destination in consideration of the allowable delay satisfaction duration.

For example, the server decision unit 102 switches the server that provides the service to the service-utilizing terminal 220 to the server 210 of the switching destination by controlling routing in the network 250. Alternatively, the server decision unit 102 may transmit communication address information of the server 210 of the switching destination to the service-utilizing terminal 220, and cause the service-utilizing terminal 220 to switch a server of a connection destination.

In the present example embodiment, the service-utilizing terminal 220 may receive a plurality of services from one or more servers 210. In this case, the decision as to whether to switch the server that provides the service to the service-utilizing terminal 220 may be made for each service-utilizing terminal 220, or may be made for each service. For example, the server switching decision unit 101 may decide whether to switch the server that provides the service to the service-utilizing terminal 220 collectively for a plurality of services provided to the service-utilizing terminal 220. Alternatively, the server switching decision unit 101 may decide whether or not to switch the server providing the service to the service-utilizing terminal 220 individually for each of a plurality of services provided to the service-utilizing terminal 220.

In addition, in a case in which the service-utilizing terminal 220 receives a plurality of services from one or more servers 210, the decision of the server of the switching destination may be made for each service-utilizing terminal 220, or may be made for each service. For example, the server decision unit 102 may decide the server of the switching destination collectively for a plurality of services provided to the service-utilizing terminal 220. Alternatively, the server decision unit 102 may decide the server of the switching destination individually for each of a plurality of services provided to the service-utilizing terminal 220.

Here, a situation in which the server of the switching destination is switched only on the basis of the delay time in a case in which the service-utilizing terminal 220 moves and switches the server is considered. In this case, it is considered that the server closest in terms of signal transmission distance from the service-utilizing terminal 220 is decided as the server of the switching destination. However, when the service-utilizing terminal 220 moves after switched to the server closest in terms of signal transmission distance, the server of the switching destination hardly satisfies the allowable delay time immediately, and the server switching is likely to occur again immediately.

As described above, in the server switching, when the server switching is performed on the basis of only the delay time at the time of switching, the server that satisfies the allowable delay time changes frequently, and frequent server switching is likely to occur. The frequent server switching is likely to lead to temporary interruptions or disconnections of application communications. In addition, in the server switching, it is necessary to transfer session information for continuing an application session from the server before switching to the server after switching, and thus the server load and the network load are likely to increase.

In the present example embodiment, the server decision unit 102 decides the server of the switching destination in consideration of the allowable delay satisfaction duration. In the present example embodiment, it is possible to suppress the frequency of server switching and suppress frequent server switching by considering how long the allowable delay time can be satisfied in the decision of the server of the switching destination. In the present example embodiment, since the frequency of server switching can be suppressed, the services can be stably provided to the service-utilizing terminal 220.

A second example embodiment of the present disclosure will be described. FIG. 4 illustrates a service provision system including a service control device according to a second example embodiment of the present disclosure. In the present example embodiment, a service provision system 300 includes a service control device 310, a plurality of base stations (gNBs) 320, a plurality of servers 330, a server 335, a mobile object 340, and a 5th generation core network (5GC) 350. In the present example embodiment, the service control device 310 is equivalent to the service control device 100 described in the first example embodiment illustrated in FIG. 1. The server 330 is equivalent to the server 210 illustrated in FIG. 2.

The mobile object 340 is configured as, for example, a land vehicle such as an automobile, a two-wheeled vehicle, a bus, a taxi, or a truck. Further, the mobile object 340 may be a train, a ship, or an aircraft, or may be a mobile robot such as an automated guided vehicle (AGV). Further, the mobile object 340 may be configured to be capable of automated driving (autonomous driving) on the basis of information of a sensor mounted on the mobile object. Furthermore, the mobile object 340 may be a pedestrian.

The service-utilizing terminal 220 illustrated in FIG. 2 is mounted on the mobile object 340. Alternatively, the user carrying the service-utilizing terminal 220 illustrated in FIG. 2 rides on the mobile object 340. Hereinafter, service provision to the service-utilizing terminal 220 mounted on the mobile object 340 and service provision to the service-utilizing terminal 220 carried by the user riding on the mobile object 340 are also referred to as service provision to the mobile object 340. The present example embodiment is an example embodiment in which the service control device 310 is applied to the service provision system 200 that provides the service to the mobile object 340.

Each of a plurality of base stations 320 is a base station in the 5G wireless communication network. Each of the base stations 320 is connected to the 5GC 350 which is a core network of the 5th generation mobile communication system via a user plane function (UPF) 370. The 5GC 350 may be connected to an external network 360. The mobile object 340 (the service-utilizing terminal 220) includes a communication device capable of performing 5G communication. The mobile object 340 is connected to the base station 320 capable of performing communication among a plurality of base stations 320. The mobile object 340 is configured to be movable. In a case in which the mobile object 340 has moved, the mobile object 340 may perform a handover process of switching the base station of the connection destination to the nearby base station 320. The base station 320 and the 5GC 350 are equivalent to network elements included in the network 250 illustrated in FIG. 2.

Each of a plurality of servers 330 and the server 335 constitute a server system which is configured to be able to provide the service to the mobile object 340. The server system may include a server (not illustrated in FIG. 4) disposed between the base station 320 and the 5GC 350. Each of a plurality of servers 330 is disposed in association with the base station 320 and connected to the base station 320 via the UPF 370. Each of the servers 330 is configured as, for example, a MEC server. The server 335 is a server which is connected to the 5GC 350.

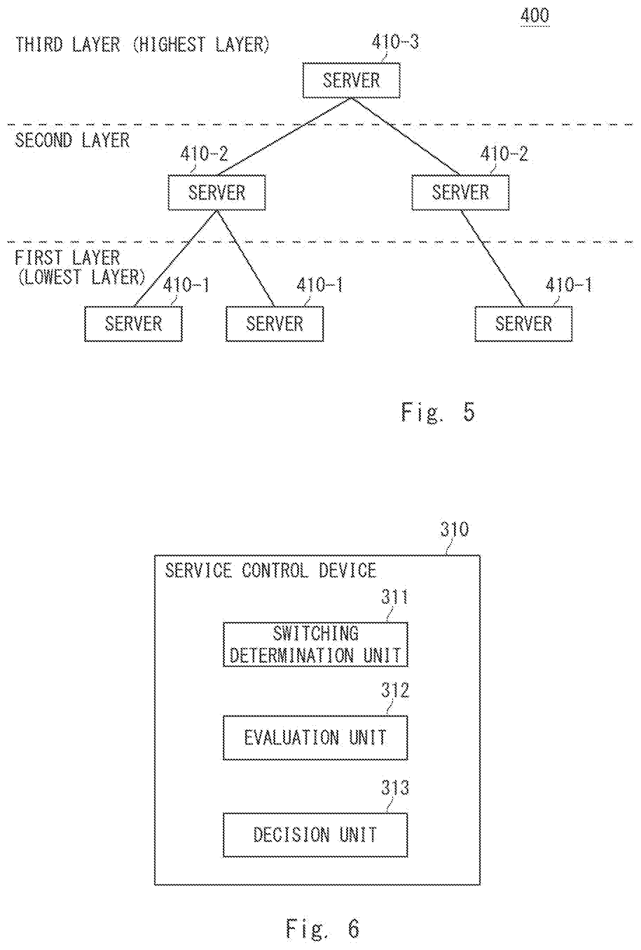

FIG. 5 illustrates a configuration example of the server system. In the example illustrated in FIG. 5, a server system 400 is hierarchized into three layers from a first layer to a third layer. It is assumed that the first layer is the lowest layer and the third layer is the highest layer. The second layer is an intermediate layer between the first layer and the third layer. Note that FIG. 5 illustrates an example in which the server system 400 is hierarchized into three layers, but the number of layers is not limited to three. The server system 400 may be hierarchized into any two or more layers. The server system 400 may not be hierarchized into a plurality of layers.

The server system 400 includes one or more servers 410-1 in the first layer, one or more servers 410-2 in the second layer, and one or more servers 410-3 in the third layer. In the hierarchized server system 400, the servers are hierarchized in accordance with the size of the management area, for example. For example, it is assumed that the management area of the server 410-1 in the first hierarchy which is the lowest layer is narrowest. The server 410-1 of the first layer is, for example, a server having an area around one intersection as the management area. The management area of the server 410-2 of the second layer is wider than the management area of the server 410-1 of the first layer which is the lower layer. The server 410-2 of the second layer is, for example, a server having an area corresponding to one city as the management area. Further, the management area of the server 410-3 of the third layer is wider than the management area of the server 410-2 of the second layer. The server 410-3 of the third layer is, for example, a server having an area corresponding to one prefecture as layer management area.

Note that, in FIG. 4, lines connecting the servers of the layers indicate an inclusive relationship of the management areas, and do not necessarily indicate a physical connection form. For example, it is assumed that there is a server of a second layer connected to a server of a first layer having an area A as the management area and a second management server having an area B as the management area. In a case in which the management area of the server of the second layer is an area C, the area C includes the area A and the area B. In addition, it is assumed that there is a server of a third layer connected to a server of the second layer having an area C as the management area. In a case in which the management area of the server of the third layer is an area D, the area D includes the area C.

The server 410-1 of the first layer illustrated in FIG. 5 is equivalent to, for example, the server 330 (MEC server) illustrated in FIG. 4. The server 410-3 of the third layer is equivalent to, for example, the server 335 illustrated in FIG. 4. The server 410-3 of the third layer may be equivalent to a server (not illustrated in FIG. 4) connected to the external network 360. The server 410-2 of the second layer may be equivalent to a server disposed between the base station 320 and the 5GC 350 (not illustrated in FIG. 4). For example, the resource amount (processing capacity, memory capacity, storage capacity, and the like) of the server 410-2 of the second layer is larger than the resource amount of the server 410-1 of the first layer. Further, the resource amount of the server 410-3 of the third layer is larger than the resource amount of the server 410-1 of the second layer.

FIG. 6 illustrates a configuration example of the service control device 310. The service control device 310 includes a switching determination unit 311, an evaluation unit 312, and a decision unit 313. The switching determination unit 311 is equivalent to the server switching decision unit 101 illustrated in FIG. 1. The decision unit 313 is equivalent to the server decision unit 102 illustrated in FIG. 1. The service control device 310 is connected to the 5GC 350 and can perform communication with a plurality of servers 330 and the servers 335 via the 5GC 350.

In the present example embodiment, the switching determination unit 311 decides whether to switch the server that provides the service to the mobile object 340. For example, the switching determination unit 311 monitors the delay time of communication with the mobile object 340 for the server that provides the service to the mobile object 340. The switching determination unit 311 determines whether the delay time exceeds an allowable value or whether the delay time is predicted to exceed the allowable value. In a case in which it is determined that the delay time exceeds the allowable value or in a case in which it is determined that the delay time is predicted to exceed the allowable value, the switching determination unit 311 makes a decision to switch the server that provides the service to the mobile object 340.

Note that various time-series prediction techniques such as a technique using an autoregressive model or a technique using deep learning can be used to predict the delay time. Alternatively, the switching determination unit 311 may decide whether to switch the server that provides the service to the mobile object 340 on the basis of the position information of the mobile object 340. As an example, the switching determination unit 311 may acquire the position information of the mobile object 340 from the mobile object 340, other management devices (not illustrated), or the like, and determine whether to switch the server that provides the service to the mobile object 340 when the mobile object 340 moves out of the management area of the server that provides the service to the mobile object 340. As another example, the switching determination unit 311 may acquire the handover event of the mobile object 340 from the mobile object 340 or the 5GC 350, and determine whether to switch the server that provides the service to the mobile object 340 when the base station to which the mobile object 340 is connected is switched.

In a case in which the switching determination unit 311 makes a decision to switch the server that provides the service to the mobile object 340, the evaluation unit 312 selects a plurality of servers (candidate servers) serving as a switching destination candidate from among the plurality of servers 330 and the servers 335. The evaluation unit 312 acquires, for example, information such as destination information, position information, speed information, and route information from the mobile object 340. The evaluation unit 312 evaluates the allowable delay satisfaction duration for each of the candidate servers on the basis of at least one of a spot of a movement destination, a movement speed, and a movement route of the mobile object 340.

For example, the evaluation unit 312 specifies the server closest to each spot through which the mobile object 340 passes as the candidate server for each spot on the basis of the route information of the mobile object 340. For each of the specified candidate servers, the evaluation unit 312 predicts the delay time related to communication between the mobile object 340 and the candidate server in a case in which the mobile object 340 is assumed to be connected to each candidate server at the current spot. On the basis of the predicted delay time of each candidate server, the evaluation unit 312 regards the candidate server, which is farthest from the current location of the mobile object 340 among the candidate servers that satisfy the allowable delay time, as the server that can satisfy the allowable delay time for the longest time, and decides the candidate server as the server of the switching destination.

For example, the evaluation unit 312 may predict the spot of the movement destination or the movement route of the mobile object 340 from the destination information of the mobile object 340. The evaluation unit 312 may acquire the destination information from, for example, a car navigation system or a route guidance application. Alternatively, for example, in a case in which the road is a one-way road, or in a case in which the road is a road on which many mobile objects travel along the road without turning right or left, the evaluation unit 312 may predict the spot of the movement destination or the movement route from a direction in which the road is headed.

The delay time may include at least one of the communication delay time depending on a signal transmission distance between the mobile object 340 and the server and a processing delay time depending on a processing load of each server. The evaluation unit 312 may predict the delay time (the communication delay time) on the basis of the signal transmission distance between the mobile object 340 and each candidate server. The signal transmission distance between the mobile object 340 and each candidate server may be estimated on the basis of, for example, the distance between the position of the mobile object 340 and the base station 320 associated with each candidate server. In general, it is considered that the communication delay time of the server 330 associated with the base station 320 to which the mobile object 340 is connected is shortest, and the communication delay time of the server connected to other base stations 320 (the base station to which the mobile object can be connected, which is different from the base station to which the mobile object is connected) or the 5GC is longer than the communication delay time of the server 330 associated with the base station 320 to which the mobile object 340 is connected. Further, the evaluation unit 312 may predict the communication delay between the mobile object located at the spot and the server by using a measurement value of a previous communication delay with the server at the spot.

The evaluation unit 312 may predict the processing delay time on the basis of the processing load of each candidate server. The processing load of the server includes, for example, a central processing unit (CPU) usage rate, a memory usage rate, the number of execution processes, a communication packet processing amount, or the like in the server. The evaluation unit 312 may acquire a correspondence relationship between the processing load of the server and the processing delay time in advance through measurement. The evaluation unit 312 may predict only one of the communication delay time and the processing delay time as the delay time, or may predict the sum of the communication delay time and the processing delay time as the delay time.

In a case in which it is assumed that the mobile object 340 moves on a predetermined movement route and the mobile object 340 continues to receive the service from one specific candidate server, the evaluation unit 312 evaluates, as the allowable delay satisfaction duration, how long the delay time within the allowable delay time can be achieved continuously. The evaluation unit 312 evaluates the allowable delay satisfaction duration for each of a plurality of candidate servers. At this time, the evaluation unit 312 may predict a change in the connected base station associated with the movement of the mobile object 340. A correspondence relationship between each spot and the connected base station acquired in advance through measurement may be used for prediction of the connected base station. Further, a correspondence relationship between each spot and the connected base station acquired in advance by using an analysis technique such as radio wave propagation simulation may be used for prediction of the connected base station. Further, the correspondence relationship between each spot and the connected base station may be generated by regarding the base station closest to each spot as the connected base station at the spot, and the correspondence relationship may be used for prediction of the connected base station.

For example, the evaluation unit 312 may calculate a period of time at which the delay time is within the allowable delay time in accordance with to the movement speed of the mobile object 340. In general, in a case in which the movement speed is high, a period of time during which the mobile object 340 stays in the area of one base station 320 is considered to be short, and thus, the duration of the period of time during which the delay time is shorter than the allowable delay time is considered to be shorter than that in a case in which the movement speed is low. The evaluation unit 312 evaluates the allowable delay satisfaction duration on the basis of the period of time during which the delay time is within the allowable delay time.

In the present example embodiment, the decision unit 313 decides the server of the switching destination from among a plurality of servers of the switching destination candidates on the basis of an evaluation result of the allowable delay satisfaction duration. For example, the decision unit 313 may decide the server having a sufficiently long allowable delay satisfaction duration as the server of the switching destination. For example, any one server of the server having the longest allowable delay satisfaction duration and the server having the allowable delay satisfaction duration exceeding a predetermined reference value may be decided as the server of the switching destination.

In a plurality of hierarchized servers, the evaluation unit 312 may select one layer among a plurality of layers sequentially from a layer side having a narrow management area, and select at least some of the servers of the selected layer as the server of the switching destination candidate. The evaluation unit 312 evaluates the allowable delay satisfaction duration for each of the candidate servers, and compares the allowable delay satisfaction durations with a first threshold value. In a case in which there are candidate servers whose allowable delay satisfaction duration is equal to or larger than the first threshold value, the evaluation unit 312 decides the server of the switching destination from the candidate servers. In a case in which there is no candidate server whose allowable delay satisfaction duration is equal to or larger than the first threshold value, the evaluation unit 312 selects a layer which is one-level higher than the selected layer, and evaluates the allowable delay satisfaction duration again for the servers belonging to the layer which is one-level higher than the selected layer. Here, the first threshold value is, for example, a minimum allowable delay satisfaction duration which is required due to characteristics of the service. The first threshold value may be the same value without depending on the provided service, or may be a different value for each service on the basis of the characteristic of the service. Further, the first threshold value may be a different value depending on an attribute of the mobile object. For example, the first threshold value for an emergency vehicle such as an ambulance may be set to a value larger than the first threshold for general vehicles.

Specifically, for example, in the server system illustrated in FIG. 5, the evaluation unit 312 first selects the first layer that is the lowest layer, and selects, for example, the server 410-1 of the first layer having an area near each intersection as the management area as the candidate server. The evaluation unit 312 evaluates the allowable delay satisfaction duration for the server 410-1. In a case in which there are the servers 410-1 whose allowable delay satisfaction duration is equal to or larger than the first threshold value, the evaluation unit 312 may decide the server 410-1 whose allowable delay satisfaction duration is equal to or larger than the first threshold value as the server of the switching destination.

In a case in which there is no server 410-1 whose allowable delay satisfaction duration is equal to or larger than the first threshold value, the evaluation unit 312 selects one upper second layer, and evaluates the allowable delay satisfaction duration for the server 410-2 of the second layer having an area corresponding to each city as the management area, for example. In a case in which there are the servers 410-2 whose allowable delay satisfaction duration is equal to or larger than the first threshold value, the evaluation unit 312 may decide the server 410-2 whose allowable delay satisfaction duration is equal to or larger than the first threshold value as the server of the switching destination. In a case in which there is no server 410-2 whose allowable delay satisfaction duration is equal to or larger than the first threshold value, the evaluation unit 312 selects one upper third layer, and evaluates the allowable delay satisfaction duration for the server 410-3 of the third layer having an area corresponding to each prefecture as the management area, for example. In this case, the decision unit 313 can search for the server whose allowable delay satisfaction duration is equal to or larger than the first threshold value from the lower layer side.

The evaluation unit 312 may select the servers of a plurality of layers as the candidate servers and evaluate the allowable delay satisfaction duration. The evaluation unit 312 selects, for example, the servers of a plurality of layers including the layer with the narrowest management area as the candidate server. The evaluation unit 312 evaluates the allowable delay satisfaction duration for each of the candidate servers. The evaluation unit 312 or the decision unit 313 compares the allowable delay satisfaction duration with a second threshold value. Here, the second threshold value is, for example, a period of time for satisfying the minimum allowable delay satisfaction duration which is required due to the characteristics of the service. The second threshold value may be the same value as or a different value from the first threshold value.

The decision unit 313 decides the server of the switching destination from among the servers of the candidate of the switching destination whose allowable delay satisfaction duration is equal to or larger than the second threshold value. For example, the decision unit 313 may decide the server having the short allowable delay satisfaction duration among the servers of the candidate of the switching destination whose allowable delay satisfaction duration is equal to or larger than the second threshold value as the server of the switching destination. The server of the candidate of the switching destination whose allowable delay satisfaction duration is equal to or larger than the second threshold value satisfies the minimum allowable delay satisfaction duration which is required due to the characteristics of all the services. Therefore, it can be said that any of the servers is suitable as the server of the switching destination. In this case, when the server having the longest allowable delay satisfaction duration is decided as the server of the switching destination, it is considered that the server of the upper layer having the wide management area is continuously selected. In a case in which the second threshold value is set to a value larger than the first threshold value and the server of the switching destination is selected as described above, the decision unit 313 can preferentially decide the server of the lower layer as the switching destination out of the server of the upper layer and the server of the lower layer.

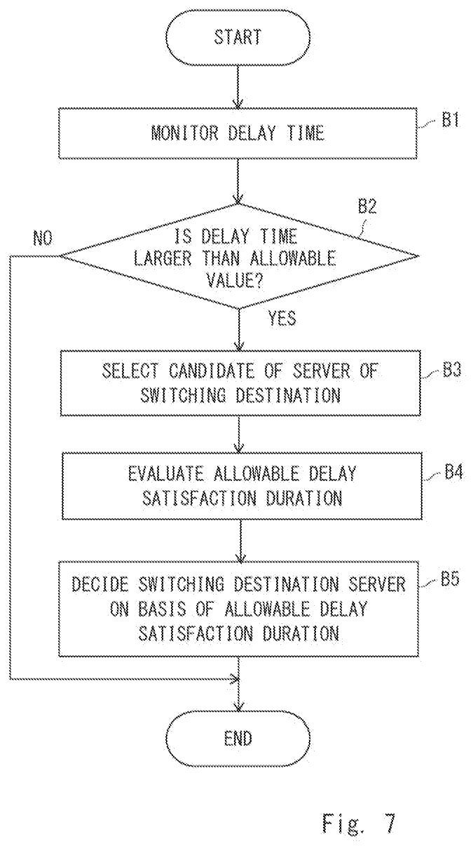

Next, an operation procedure in the present example embodiment will be described. FIG. 7 illustrates an operation procedure in the service control device 310. The switching determination unit 311 monitors the delay time of the server that provides the service to the mobile object 340 (step B1). The switching determination unit 311 determines whether the delay time exceeds the allowable value (step B2). In step B2, the switching determination unit 311 may decide whether the delay time is predicted to exceed the allowable value. In a case in which it is determined in step B2 that the delay time exceeds the allowable value or the delay time is predicted to exceed the allowable value, the switching determination unit 311 makes a decision to switch the server that provides the service to the mobile object 340.

In a case in which the switching determination unit 311 makes a decision to switch the server that provides the service to the mobile object 340, the evaluation unit 312 selects a plurality of servers (candidate servers) serving as the switching destination candidate from among the plurality of servers 330 and the servers 335 (step B3). The evaluation unit 312, the evaluation unit 312 evaluates the allowable delay satisfaction duration for each of the candidate servers (step B4). In step B4, for example, the evaluation unit 312 evaluates the allowable delay satisfaction duration on the basis of at least one of a spot of a movement destination, a movement speed, and a movement route of the mobile object 340. In step B4, for example, the evaluation unit 312 may predict the delay time on the basis of at least one of the processing load of the candidate server and the signal transmission distance between the mobile object 340 and the candidate server. The evaluation unit 312 evaluates the allowable delay satisfaction duration on the basis of the period of time during which the predicted delay time is within the allowable delay time.

The decision unit 313 decides the server of the switching destination on the basis of the allowable delay satisfaction duration evaluated in step B4 (step B5). After the server of the switching destination is decided, the decision unit 313 may switch the server to which the mobile object 340 is connected to the server decided in step B5 by controlling routing in the 5GC 350. Alternatively, the decision unit 313 may notify the mobile object 340 of the communication address information of the server decided in step B5. In this case, the mobile object 340 may establish connection with the server with the notified communication address information and receive the service from the connected server. Note that the control of the routing in the 5GC 350 may be performed by issuing an instruction to a network exposure function (NEF).

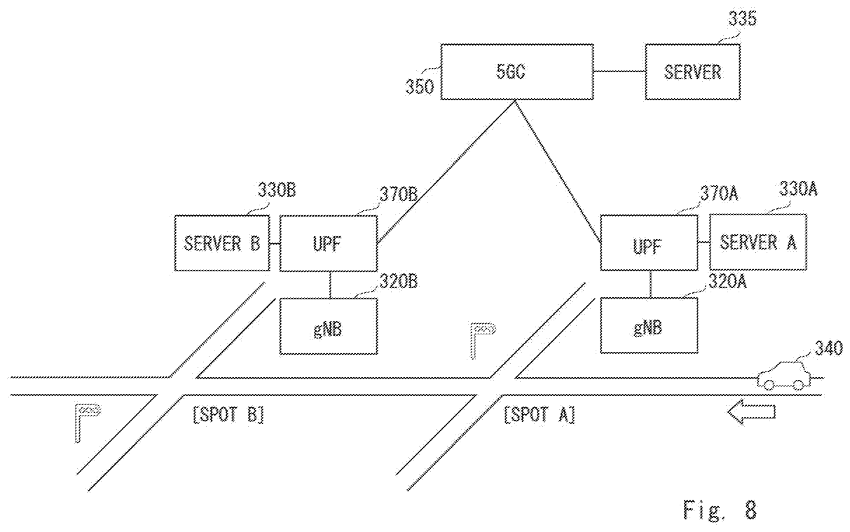

FIG. 8 schematically illustrates an example of the server switching. In an example illustrated in FIG. 8, a server 330A (server A) is connected to a base station 320A installed at a spot A via a UPF 370A. Further, a server 330B (server B) is connected to a base station 320B installed at a spot B via a UPF 370B. The UPFs 370A and 370B are nodes which are responsible for processing user plane data in the 5G system. The servers 330A and 330B are assumed to be MEC servers. On the other hand, the server 335 connected to the 5GC 350 is assumed to be a host server. The server 335 is also referred to as a MEC server of a higher layer.

It is assumed that the mobile object 340 receives the service from the server (not illustrated in FIG. 8). The switching determination unit 311 decides that the delay time exceeds the allowable value and makes a decision to switch the server that proves the service to the mobile object 340. In the example illustrated in FIG. 8, the evaluation unit 312 predicts that the mobile object 340 passes through the spot A and moves toward the spot B. In this case, the evaluation unit 312 selects, for example, the servers 330A and 330B and the server 335 as the candidate servers.

The evaluation unit 312 calculates the delay time at each time when the mobile object 340 receives the service from the server 330A. Also for the servers 330B and 335, the evaluation unit 312 calculates, for each server, the delay time at each time when the mobile object 340 receives the service from each server. The delay time may change over time. That is, the delay time can be expressed as a function of time. The evaluation unit 312 evaluates, on the basis of the calculated delay time, each of the allowable delay satisfaction durations in a case in which the servers 330A, 330B, and 335 provide the services to the mobile object 340.

The evaluation unit 312 compares the evaluation results of the allowable delay satisfaction durations of the respective servers. The evaluation unit 312 decides the server that provides the service to the mobile object 340 on the basis of the evaluation results. For example, in a case in which the movement speed of the mobile object 340 is relatively slow, it is considered that the mobile object 340 stays in the area of the base station 320A installed at the spot A for a long time. In this case, the decision unit 313 decides the server 330A as the server of the switching destination. The mobile object 340 receives the service from the server 330A, for example, by changing the routing in the 5GC 350.

As another case, a situation in which the mobile object 340 having a relatively high movement speed leaves the area of the base station 320A and enters the area of the base station 320B installed at the spot B is considered. In this case, when the allowable delay satisfaction duration of the server 330B is longer than the allowable delay satisfaction duration of the server 330A, the decision unit 313 can decide the server 330B as the server of the switching destination. In a case in which the mobile object 340 moves toward the spot B, the period of time during which the mobile object 340 can receive the service from the server 330B is considered to be longer than the period of time during which the mobile object 340 can receive the service from the server 330A. In this case, the frequency of server switching can be suppressed by using the server 330B as the server of the switching destination instead of the server 330A.

As still another case, a situation in which the movement speed of the mobile object 340 is higher is considered. In this case, the allowable delay satisfaction duration of the servers 330A and 330B becomes relatively short, and in a case in which the allowable delay satisfaction duration of the server 335 that manages a wider area is relatively long, the decision unit 313 can decide the server 335 as the server of the switching destination. In a case in which the movement speed is high, the frequency of server switching can be suppressed by using the server 335 that is the higher server as the server of the switching destination instead of the servers 330A and 330B that are the MEC servers.

In the present example embodiment, the evaluation unit 312 evaluates the allowable delay satisfaction duration for the candidate of the server of the switching destination. The decision unit 313 decides the server of the switching destination in consideration of the evaluation result of the allowable delay satisfaction duration. In this way, in a case in which the mobile object 340 moves, rather than the MEC server having the short signal transmission distance, the MEC server having the long allowable delay satisfaction duration that can be stably connected can be set as the server of the switching destination. In a case in which the server that provides the service to the mobile object 340 is switched, the frequency of the server switching associated with the movement of the mobile object 340 can be suppressed by setting the MEC server having the long allowable delay satisfaction continuation as the server of the switching destination. In the present example embodiment, it is possible to suppress the frequent server switching and stably provide the services to the mobile object 340.

Note that the above example embodiment has been described with the example in which in a case in which the service control device makes a decision to switch the server that provides the service to the service-utilizing terminal, the service control device decides the server of the switching destination. However, the present disclosure is not limited thereto. For example, the service control device may periodically evaluate the allowable delay satisfaction duration of each server, and in a case in which the server having the allowable delay satisfaction duration of a certain value or more is found, the service control device may decide the server as the server of the switching destination. More specifically, the evaluation unit 312 periodically evaluates the allowable delay satisfaction durations for some servers regardless of whether a decision to switch the server is made. The decision unit 313 determines whether there is a server having an allowable delay satisfaction duration of a certain value or more on the basis of the evaluation result in the evaluation unit 312. In a case in which there is a server having an allowable delay satisfaction duration of a certain value or more, the decision unit 313 may decide the server as the server of the switching destination.

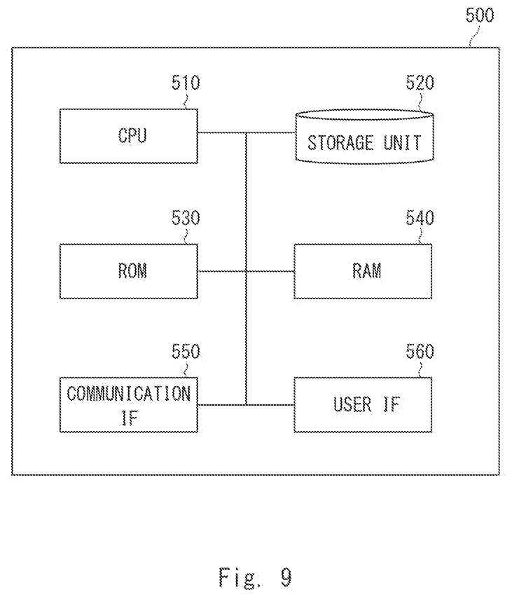

In the present disclosure, the service control devices 100 and 310 may be configured using a computer device (server device). FIG. 9 illustrates a configuration example of a computer device that can be used for the service control devices 100 and 310. A computer device 500 includes a control unit (CPU) 510, a storage unit 520, a read only memory (ROM) 530, a random access memory (RAM) 540, a communication interface (IF) 550, and a user interface 560.

The communication interface 550 is an interface for connecting the computer device 500 to a communication network through wired communication means, wireless communication means, or the like. The user interface 560 includes, for example, a display unit such as a display. The user interface 560 also includes an input unit such as a keyboard, a mouse, or a touch panel.

The storage unit 520 is an auxiliary storage device that can hold various types of data. The storage unit 520 need not to be necessarily part of the computer device 500 and may be an external storage device or a cloud storage connected to the computer device 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores, for example, various programs for implementing the function of each unit in the service control device 100 or 310.

The aforementioned programs can be stored and supplied to the computer device 500 using various types of non-transitory computer readable media. Non-transitory computer readable media include various types of tangible storage media. Examples of non-transitory computer readable media include magnetic storage media such as floppy disks, magnetic tapes, and hard disk drives, optical magnetic storage media such as magneto-optical disks, optical disk media such as CD (Compact Disc) and DVD (Digital Versatile Disk), and semiconductor memories such as mask ROM, PROM (Programmable ROM), EPROM (Erasable PROM), flash ROM, and RAM. Further, the programs may be provided to computers using various types of transitory computer readable media. Examples of the transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 loads a program, stored in the storage unit 520 or the ROM 530, in the RAM 540, and executes the loaded program. The function of each unit in the service control devices 100 and 310 can be implemented such that the CPU 510 executes a program. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure. For example, each of the above example embodiments and the matters described in each of the above example embodiments can be appropriately combined.

For example, some or all of the above-described example embodiments may be described as the following supplementary notes, but the present disclosure is not limited to the following supplementary notes.

### Supplementary Note 1

A service control system including:
a server switching decision unit configured to decide whether to switch a server that provides a service to a service-utilizing terminal that receives the service from the server; and
a server decision unit configured to decide a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

### Supplementary Note 2

The service control system according to supplementary note 1, in which the server switching decision unit decides whether to switch the server that provides the service to the service-utilizing terminal on the basis of a delay time between the service-utilizing terminal and the server that provides the service to the service-utilizing terminal.

### Supplementary Note 3

The service control system according to supplementary note 1 or 2, further including an evaluation unit configured to evaluate the allowable delay satisfaction duration for each of a plurality of servers of a candidate of a switching destination on the basis of at least one of a spot of a movement destination, a movement speed, and a movement route of the service-utilizing terminal,
in which the server decision unit decides the server of the switching destination from among the plurality of servers of the candidate of the switching destination on the basis of an evaluation result of the allowable delay satisfaction duration.

### Supplementary Note 4

The service control system according to supplementary note 3, in which
the plurality of servers are hierarchized into a plurality of layers, each of which comprising one or more servers and each of which having a management area whose size is different from each other, and
the evaluation unit selects one of the plurality of layers sequentially from a layer side with a narrow management area, evaluates the allowable delay satisfaction duration by using at least some of the servers of the selected layer as the servers of the candidate of the switching destination, decides the server of the switching destination from among the servers of the candidate of the switching destination in a case in which there is the server of the candidate of the switching destination whose allowable delay satisfaction duration is equal to or larger than a first threshold value, selects a layer which is one-level higher than the selected layer in a case in which there is no server of the candidate of the switching destination whose allowable delay satisfaction duration is equal to or larger than the first threshold value, and evaluates the allowable delay satisfaction duration by using at least some of the servers of the selected layer as the servers of the candidate of the switching destination.

### Supplementary Note 5

The service control system according to supplementary note 3, in which
the plurality of servers are hierarchized into a plurality of layers, each of which comprising one or more servers and each of which having a management area whose size is different from each other,
the evaluation unit evaluates the allowable delay satisfaction duration by using the servers of the plurality of layers including a layer with the narrowest management area as the servers of the candidate of the switching destination, and
the server decision unit decides the server of the switching destination from among the servers of the candidate of the switching destination whose allowable delay satisfaction duration is equal to or larger than a second threshold value.

### Supplementary Note 6

The service control system according to any one of supplementary notes 3 to 5, in which the evaluation unit predicts the delay time on the basis of a processing load of the servers of the candidate of the switching destination and a signal transmission distance between the service-utilizing terminal and the servers of the candidate of the switching destination, and evaluates the allowable delay satisfaction duration on the basis of a period of time during which the predicted delay time is within the allowable delay time.

### Supplementary Note 7

A service control device including:
a server switching decision unit configured to decide whether to switch a server that provides a service to a service-utilizing terminal that receives the service from the server; and
a server decision unit configured to decide a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

### Supplementary Note 8

The service control device according to supplementary note 7, in which the server switching decision unit decides whether to switch the server that provides the service to the service-utilizing terminal on the basis of a delay time between the service-utilizing terminal and the server that provides the service to the service-utilizing terminal.

### Supplementary Note 9

The service control device according to supplementary note 7 or 8, further including an evaluation unit configured to evaluate the allowable delay satisfaction duration for each of a plurality of servers of a candidate of a switching destination on the basis of at least one of a spot of a movement destination, a movement speed, and a movement route of the service-utilizing terminal,
in which the server decision unit decides the server of the switching destination from among the plurality of servers of the candidate of the switching destination on the basis of an evaluation result of the allowable delay satisfaction duration.

### Supplementary Note 10

The service control device according to supplementary note 9, in which
the plurality of servers are hierarchized into a plurality of layers, each of which comprising one or more servers and each of which having a management area whose size is different from each other, and
the evaluation unit selects one of the plurality of layers sequentially from a layer side with a narrow management area, evaluates the allowable delay satisfaction duration by using at least some of the servers of the selected layer as the servers of the candidate of the switching destination, decides the server of the switching destination from among the servers of the candidate of the switching destination in a case in which there is the server of the candidate of the switching destination whose allowable delay satisfaction duration is equal to or larger than a first threshold value, selects a layer which is one-level higher than the selected layer in a case in which there is no server of the candidate of the switching destination whose allowable delay satisfaction duration is equal to or larger than the first threshold value, and evaluates the allowable delay satisfaction duration by using at least some of the servers of the selected layer as the servers of the candidate of the switching destination.

### Supplementary Note 11

The service control device according to supplementary note 9, in which
the plurality of servers are hierarchized into a plurality of layers, each of which comprising one or more servers and each of which having a management area whose size is different from each other,
the evaluation unit evaluates the allowable delay satisfaction duration by using the servers of the plurality of layers including a layer with the narrowest management area as the servers of the candidate of the switching destination, and
the server decision unit decides the server of the switching destination from among the servers of the candidate of the switching destination whose allowable delay satisfaction duration is equal to or larger than a second threshold value.

### Supplementary Note 12

The service control device according to any one of supplementary notes 9 to 11, in which the evaluation unit predicts the delay time on the basis of a processing load of the servers of the candidate of the switching destination and a signal transmission distance between the service-utilizing terminal and the servers of the candidate of the switching destination, and evaluates the allowable delay satisfaction duration on the basis of a period of time during which the predicted delay time is within the allowable delay time.

### Supplementary Note 13

A service control method including:
deciding whether to switch a server that provides a service to a service-utilizing terminal that receives the service from the server; and
deciding a server of a switching destination, when a decision to switch the server is made, from among a plurality of servers that are able to provide the service to the service-utilizing terminal in consideration of an allowable delay satisfaction duration indicating a length of time during which the service can be provided to the service-utilizing terminal with a delay time within an allowable delay time.

### Supplementary Note 14

The service control method according to supplementary note 13, in which the deciding of whether to switch the server includes deciding whether to switch the server that provides the service to the service-utilizing terminal on the basis of a delay time between the service-utilizing terminal and the server that provides the service to the service-utilizing terminal.

### Supplementary Note 15

The service control method according to supplementary note 13 or 14, further including evaluating the allowable delay satisfaction duration for each of a plurality of servers of a candidate of a switching destination on the basis of at least one of a spot of a movement destination, a movement speed, and a movement route of the service-utilizing terminal,
in which the deciding of the server of the switching destination includes deciding the server of the switching destination from among the plurality of servers of the candidate of the switching destination on the basis of an evaluation result of the allowable delay satisfaction duration.

### Supplementary Note 16

The service control method according to supplementary note 15, in which
the plurality of servers are hierarchized into a plurality of layers, each of which comprising one or more servers and each of which having a management area whose size is different from each other, and
the evaluating of the allowable delay satisfaction duration includes selecting one of the plurality of layers sequentially from a layer side with a narrow management area, evaluating the allowable delay satisfaction duration by using at least some of the servers of the selected layer as the servers of the candidate of the switching destination, deciding the server of the switching destination from among the servers of the candidate of the switching destination in a case in which there is the server of the candidate of the switching destination whose allowable delay satisfaction duration is equal to or larger than a first threshold value, selecting a layer which is one-level higher than the selected layer in a case in which there is no server of the candidate of the switching destination whose allowable delay satisfaction duration is equal to or larger than the first threshold value, and evaluating the allowable delay satisfaction duration by using at least some of the servers of the selected layer as the servers of the candidate of the switching destination.

### Supplementary Note 17

The service control method according to supplementary note 15, in which
the plurality of servers are hierarchized into a plurality of layers, each of which comprises one or more servers and each of which has a management area whose size is different from each other,
the evaluating of the allowable delay satisfaction duration includes evaluating the allowable delay satisfaction duration by using the servers of the plurality of layers including a layer with the narrowest management area as the servers of the candidate of the switching destination, and
the deciding of the server of the switching destination includes deciding the server of the switching destination from among the servers of the candidate of the switching destination whose allowable delay satisfaction duration is equal to or larger than a second threshold value.

### Supplementary Note 18

The service control method according to any one of supplementary notes 15 to 17, in which the evaluating of the allowable delay satisfaction duration includes predicting the delay time on the basis of a processing load of the servers of the candidate of the switching destination and a signal transmission distance between the service-utilizing terminal and the servers of the candidate of the switching destination, and evaluating the allowable delay satisfaction duration on the basis of a period of time during which the predicted delay time is within the allowable delay time.

### Reference Signs List

100 SERVICE CONTROL DEVICE
101 SERVER SWITCHING DECISION UNIT
102 SERVER DECISION UNIT
200 SERVICE PROVISION SYSTEM
210 SERVER
220 SERVICE-UTILIZING TERMINAL
300 SERVICE PROVISION SYSTEM
310 SERVICE CONTROL DEVICE
320 BASE STATION
330, 335 SERVER
340 MOBILE OBJECT
350 5GC
360 EXTERNAL NETWORK
370 UPF
400 SERVER SYSTEM
410 SERVER
500 COMPUTER DEVICE
510 CPU
520 STORAGE UNIT
530 ROM
540 RAM
550 COMMUNICATION INTERFACE
560 USER INTERFACE

What is claimed is:

1. A service control system comprising:
at least one memory storing instructions; and
at least one processor configured to execute the instructions to:
decide whether to switch a server that provides a service to a service-utilizing terminal that receives the service from the server; and
a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

2. The service control system according to claim 1, wherein the at least one processor is configured to execute the instructions to decide whether to switch the server that provides the service to the service-utilizing terminal based on a delay time between the service-utilizing terminal and the server that provides the service to the service-utilizing terminal.

3. The service control system according to claim 1, wherein the at least one processor is further configured to execute the instructions to evaluate the allowable delay satisfaction duration for each of a plurality of servers of a candidate of a switching destination based on at least one of a spot of a movement destination, a movement speed, or a movement route of the service-utilizing terminal, and
wherein the at least one processor is configured to execute the instructions to decide the server of the switching destination from among the plurality of servers of the candidate of the switching destination based on an evaluation result of the allowable delay satisfaction duration.

4. The service control system according to claim 3, wherein
the plurality of servers are hierarchized into a plurality of layers, each of which comprising one or more servers and each of which having a management area whose size is different from each other, and
the at least one processor is configured to execute the instructions to select one of the plurality of layers sequentially from a layer side with a narrow management area, evaluate the allowable delay satisfaction duration by using at least some of the servers of the selected layer as the servers of the candidate of the switching destination, decide the server of the switching destination from among the servers of the candidate of the switching destination in a case in which there is the server of the candidate of the switching destination whose allowable delay satisfaction duration is equal to or larger than a first threshold value, select a layer which is one-level higher than the selected layer in a case in which there is no server of the candidate of the switching destination whose allowable delay satisfaction duration is equal to or larger than the first threshold value, and evaluate the allowable delay satisfaction duration by using at least some of the servers of the selected layer as the servers of the candidate of the switching destination.

5. The service control system according to claim 3, wherein
the plurality of servers are hierarchized into a plurality of layers, each of which comprising one or more servers and each of which having a management area whose size is different from each other,
the at least one processor is configured to execute the instructions to:
evaluate the allowable delay satisfaction duration by using the servers of the plurality of layers including a layer with the narrowest management area as the servers of the candidate of the switching destination, and
decide the server of the switching destination from among the servers of the candidate of the switching destination whose allowable delay satisfaction duration is equal to or larger than a second threshold value.

6. The service control system according to claim 3, wherein the at least one processor is configured to execute the instructions to predict the delay time based on at least one of a processing load of the servers of the candidate of the switching destination or a signal transmission distance between the service-utilizing terminal and the servers of the candidate of the switching destination, and evaluate the allowable delay satisfaction duration based on a period of time during which the predicted delay time is within the allowable delay time.

7. A service control device comprising:
at least one memory storing instructions; and
at least one processor configured to execute the instructions to:
decide whether to switch a server that provides a service to a service-utilizing terminal that receives the service from the server; and
decide a server of a switching destination, when the server switching decision unit makes a decision to switch the server, from among a plurality of servers that are able to provide the service to the service-utilizing terminal in consideration of an allowable delay satisfaction duration indicating a length of time during which the service can be provided to the service-utilizing terminal with a delay time within an allowable delay time.

8. The service control device according to claim 7, wherein the at least one processor is configured to execute the instructions to decide whether to switch the server that provides the service to the service-utilizing terminal based on a delay time between the service-utilizing terminal and the server that provides the service to the service-utilizing terminal.

9. The service control device according to claim 7, wherein the at least one processor is further configured to execute the instructions to evaluate the allowable delay satisfaction duration for each of a plurality of servers of a candidate of a switching destination based on at least one of a spot of a movement destination, a movement speed, or a movement route of the service-utilizing terminal, and
wherein the at least one processor is configured to execute the instructions to decide the server of the switching destination from among the plurality of servers of the candidate of the switching destination based on an evaluation result of the allowable delay satisfaction duration.

10. The service control device according to claim 9, wherein
the plurality of servers are hierarchized into a plurality of layers, each of which comprising one or more servers and each of which having a management area whose size is different from each other, and
the at least one processor is configured to execute the instructions to select one of the plurality of layers sequentially from a layer side with a narrow management area, evaluate the allowable delay satisfaction duration by using at least some of the servers of the selected layer as the servers of the candidate of the switching destination, decide the server of the switching destination from among the servers of the candidate of the switching destination in a case in which there is the server of the candidate of the switching destination whose allowable delay satisfaction duration is equal to or larger than a first threshold value, select a layer which is one-level higher than the selected layer in a case in which there is no server of the candidate of the switching destination whose allowable delay satisfaction duration is equal to or larger than the first threshold value, and evaluate the allowable delay satisfaction duration by using at least some of the servers of the selected layer as the servers of the candidate of the switching destination.

11. The service control device according to claim 9, wherein
the plurality of servers are hierarchized into a plurality of layers, each of which comprising one or more servers and each of which having a management area whose size is different from each other,
the at least one processor is configured to execute the instructions to:
evaluate the allowable delay satisfaction duration by using the servers of the plurality of layers including a layer with the narrowest management area as the servers of the candidate of the switching destination, and
decide the server of the switching destination from among the servers of the candidate of the switching destination whose allowable delay satisfaction duration is equal to or larger than a second threshold value.

12. The service control device according to claim 9, wherein the at least one processor is configured to execute the instructions to predict the delay time based on a processing load of the servers of the candidate of the switching destination and a signal transmission distance between the service-utilizing terminal and the servers of the candidate of the switching destination, and evaluate the allowable delay satisfaction duration based on a period of time during which the predicted delay time is within the allowable delay time.

13. A service control method comprising:
deciding whether to switch a server that provides a service to a service-utilizing terminal that receives the service from the server; and
deciding a server of a switching destination, when a decision to switch the server is made, from among a plurality of servers that are able to provide the service to the service-utilizing terminal in consideration of an allowable delay satisfaction duration indicating a length of time during which the service can be provided to the service-utilizing terminal with a delay time within an allowable delay time.

14. The service control method according to claim 13, wherein the deciding of whether to switch the server includes deciding whether to switch the server that provides the service to the service-utilizing terminal based on a delay time between the service-utilizing terminal and the server that provides the service to the service-utilizing terminal.

15. The service control method according to claim 13, further comprising evaluating the allowable delay satisfaction duration for each of a plurality of servers of a candidate of a switching destination based on at least one of a spot of a movement destination, a movement speed, or a movement route of the service-utilizing terminal,
wherein the deciding of the server of the switching destination includes deciding the server of the switching destination from among the plurality of servers of the candidate of the switching destination based on an evaluation result of the allowable delay satisfaction duration.

16. The service control method according to claim 15, wherein
the plurality of servers are hierarchized into a plurality of layers, each of which comprising one or more servers and each of which having a management area whose size is different from each other, and
the evaluating of the allowable delay satisfaction duration includes selecting one of the plurality of layers sequentially from a layer side with a narrow management area, evaluating the allowable delay satisfaction duration by using at least some of the servers of the selected layer as the servers of the candidate of the switching destination, deciding the server of the switching destination from among the servers of the candidate of the switching destination in a case in which there is the server of the candidate of the switching destination whose allowable delay satisfaction duration is equal to or larger than a first threshold value, selecting a layer which is one-level higher than the selected layer in a case in which there is no server of the candidate of the switching destination whose allowable delay satisfaction duration is equal to or larger than the first threshold value, and evaluating the allowable delay satisfaction duration by using at least some of the servers of the selected layer as the servers of the candidate of the switching destination.

17. The service control method according to claim 15, wherein
the plurality of servers are hierarchized into a plurality of layers, each of which comprising one or more servers and each of which having a management area whose size is different from each other,
the evaluating of the allowable delay satisfaction duration includes evaluating the allowable delay satisfaction duration by using the servers of the plurality of layers including a layer with the narrowest management area as the servers of the candidate of the switching destination, and
the deciding of the server of the switching destination includes deciding the server of the switching destination from among the servers of the candidate of the switching destination whose allowable delay satisfaction duration is equal to or larger than a second threshold value.

18. The service control method according to claim 15, wherein the evaluating of the allowable delay satisfaction duration includes predicting the delay time on the basis of a processing load of the servers of the candidate of the switching destination and a signal transmission distance between the service-utilizing terminal and the servers of the candidate of the switching destination, and evaluating the allowable delay satisfaction duration on the basis of a period of time during which the predicted delay time is within the allowable delay time.
